(19) United States
(12) Patent Application Publication
(10) Pub. No.: US 2006/0069634 A1
(43) Pub. Date: Mar. 30, 2006

(54) Methods and systems for providing enhanced capital advantaged preferred securities

(75) Inventors: Erin Callan, New York, NY (US); John Curran, Bronxville, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/295,276

(22) Filed: Dec. 5, 2005

Related U.S. Application Data
(60) Provisional application No. 60/681,899, filed on May 16, 2005.

(51) Int. Cl. G06Q 40/00

(52) U.S. Cl. 705/35

(57) ABSTRACT

In one aspect, the invention comprises a method comprising: (a) forming a limited liability company (“LLC”) operable to issue LLC preferred securities; (b) forming a trust operable to issue trust preferred securities and to purchase LLC preferred securities from the LLC; and (c) issuing subordinated notes with at least a 30-year maturity to the LLC. In another aspect, the invention comprises a method comprising: (a) forming a trust operable to issue trust preferred securities and to purchase LLC preferred securities; and (b) receiving over the computer network subordinated notes with a maturity of at least 30 years from a parent. In another aspect, the invention comprises a security that: (a) is tax deductible, and (b) receives equity credit above 50% from Moody's and S&P.

### CROSS-REFERENCE TO RELATED APPLICATIONS

This application claims the benefit of U.S. Provisional Application No. 60/681,899, filed May 16, 2005. The entire contents of that provisional application are incorporated herein by reference.

### BACKGROUND & SUMMARY

Two current structures available to issuers are trust preferred or perpetual preferred stock with equity enhancements (mandatory deferral). Perpetual preferred has become more attractive recently due to changes at the rating agencies.

Trust preferred securities are dated cumulative preferred securities issued out of a special purpose entity, usually in the form of a trust, in which a parent owns all of the common securities. The trust's sole asset is a deeply subordinated note issued by the parent. The subordinated note, which is senior only to the Parent's common and preferred stock, has terms that generally mirror those of the trust preferred securities.

The terms of the trust preferred securities allow dividends to be deferred for at least a 20 consecutive quarter period without creating an event of default or acceleration. After the deferral of dividends for this 20 quarter period, if the Parent fails to pay the cumulative dividend amount owed to investors, an event of default and acceleration occurs, giving investors the right to acquire the subordinated note issued by the Parent. At the same time, the Parent's obligation to pay principal and interest on the underlying junior subordinated note accelerates and the note becomes immediately due and payable.

A key advantage of trust preferred securities to the Parent is that for tax purposes the dividends paid on trust preferred securities, unlike those paid on directly issued preferred stock, are a tax deductible interest expense. The IRS ignores the trust and focuses on the interest payments on the underlying subordinated note.

Trust Preferred Securities receive limited equity credit from the rating agencies (Moody's: 0%; S&P: 40% (corporates) and 100% (financials)).

Perpetual preferred stock has no fixed maturity date and cannot be redeemed at the option of the holder. Perpetual preferred stock, with certain features, can obtain high equity credit (Moody's: 75-100%; S&P: up to 60% (corporates) and 100% (financials)) but is more expensive capital since it is not tax deductible—dividends are paid out of after tax earnings and profits.

A preferred embodiment of the present invention provides many of the advantages of the two products described above, while avoiding many of the disadvantages. The preferred embodiment provides securities (enhanced capital advantaged preferred securities (“ECAPS”) that are tax-deductible yet also receive equity credit similar to that of perpetual preferred stock. This preferably is accomplished by: (1) the LLC and the trust issuing 60-year securities to investors; (2) an optional and mandatory deferral feature is added to ensure high equity content [Alternatively, the LLC can be eliminated and the Trust will directly make a 60 yr+deeply subordinated loan to Parent]; (3) a required sale of common or preferred stock to pay distributions after 20 periods of optional deferral or immediately upon occurrence of mandatory deferral to allow preservation of existing cash for creditors, while paying distributions as required for tax purposes; (4) a parent creating an LLC and a trust contributing capital to the LLC; (5) the LLC making a deeply subordinated dated loan (30+years) back to the company; (6) at maturity of the initial loan, the LLC will likely reinvest in similar deeply subordinated loans of the parent or affiliates.

Embodiments of the present invention preferably comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, preferably are transmitted electronically over a computer network. Further, all data preferably is stored in one or more electronic databases.

In one aspect, the invention comprises a computer based method comprising: (a) forming a limited liability company (“LLC”) operable to issue LLC preferred securities over a computer network; (b) forming a trust operable to issue trust preferred securities over the computer network and to purchase LLC preferred securities from the LLC over the computer network; and (c) electronically issuing over the computer network subordinated notes with at least a 30-year maturity to the LLC.

In another aspect, the invention comprises a computer based method comprising: (a) forming a trust operable to issue trust preferred securities over a computer network and to purchase LLC preferred securities over the computer network; and (b) electronically receiving over the computer network subordinated notes with a maturity of at least 30 years from a parent.

In another aspect, the invention comprises a method comprising: (a) forming a limited liability company (“LLC”) operable to issue LLC preferred securities; (b) forming a trust operable to issue trust preferred securities and to purchase LLC preferred securities from the LLC; and (c) issuing subordinated notes to the LLC.

In various embodiments: (1) the LLC is operable to invest proceeds from redemption of the subordinated notes into long-dated subordinated loans; (2) the subordinated notes have a maturity of at least 30 years; (3) the trust preferred securities are 60-year dated preferred securities; (4) the LLC preferred securities are 60-year dated preferred securities; (5) the LLC is operable to invest proceeds from redemption of the subordinated notes into short term, high quality third party assets; (6) the subordinated notes are 20% loaned to affiliates; (7) the method further comprises guaranteeing the subordinated notes; (8) the method further comprises contributing up to 5% of total capital for a managing member interest in the LLC; and (9) the LLC and the trust are covered by a support agreement that ensures that each will have enough assets to pay its obligations.

In another aspect, the invention comprises a method comprising: (a) forming a trust operable to issue trust preferred securities and to purchase LLC preferred securities; and (b) receiving subordinated notes with a maturity of at least 30 years from a parent in exchange for a loan to the parent.

In various embodiment: (1) the subordinated notes have a deferral period of 10-12 years; (2) after a predetermined period of optional deferral, the parent is obligated to sell common or preferred stock in order to fund distribution payments; (3) the predetermined period is five years; (4) upon mandatory deferral, the parent is obligated to issue common or preferred stock in order to fund distribution payments; (5) after 10-12 years of deferral, holders of the subordinated notes have a right to accelerate the loan and the notes become immediately due and payable.

In another aspect, the invention comprises a security that: (a) is tax deductible, and (b) receives equity credit above 50% from Moody's and S&P.

In various embodiments: (1) the equity credit is similar to that of perpetual preferred stock; (2) the security is a preferred security issued by a trust, wherein the trust is operable to purchase LLC preferred securities from an LLC, and wherein the LLC is operable to purchase subordinated notes from a parent with funds received from the trust in exchange for the LLC preferred securities; (3) the LLC is operable to invest proceeds from redemption of the subordinated notes into long-dated subordinated loans; (4) the LLC preferred securities are 60-year dated preferred securities; (5) the security is a 60-year dated preferred security; (6) the LLC is operable to invest proceeds from redemption of the subordinated notes into short term, high quality third party assets; (7) the subordinated notes are 20% loaned to affiliates; (8) the subordinated notes are guaranteed by the parent; and (9) the LLC and the trust are covered by a support agreement that ensures that each will have enough assets to pay its obligations.

### BRIEF DESCRIPTION OF THE DRAWINGS

FIG. 1 illustrates a preferred ECAPS structure.

FIG. 2 depicts preferred flow for cash and securities.

FIG. 3 depicts an alternate embodiment, with a foreign parent.

### DETAILED DESCRIPTION OF PREFERRED EMBODIMENTS

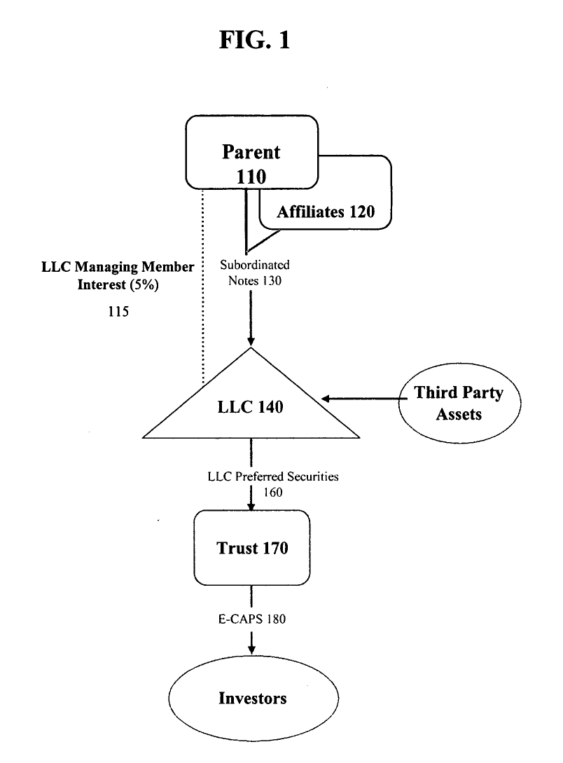

In one preferred embodiment, referring to FIG. 1, Parent 110 forms Limited Liability Company (LLC) 140 and contributes minimal proceeds 115 equal to 0-5% of total capital (including LLC preferred) for the managing member interest. Parent also causes a Delaware Trust 170 to be formed. Parent owns all of the common securities of the LLC and the Trust.

Trust 170 issues 60-year preferred securities with capital replacement language—ECAPS 180—to investors and purchases mirror LLC preferred securities 160.

LLC will on-loan to Parent 110 the proceeds from the ECAPS offering in the form of subordinated notes 130 with a 30-year maturity. That is, the Parent issues the notes to the LLC and pays interest on the notes to the LLC. Interest payments on the subordinated notes 130 will fund distribution payments for ECAPS 180. The Parent preferably guarantees the trust preferred securities and, of course, the subordinated notes. These guarantees will be recognized by those skilled in the art as required under the Securities Act of 1940.

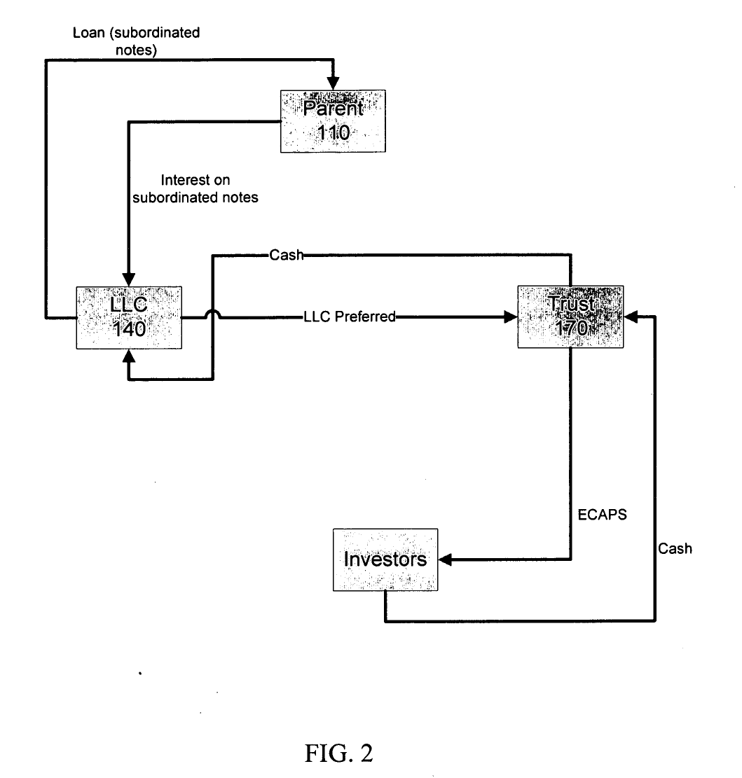

FIG. 2 depicts flow of cash and securities between the various entities.

At initial maturity of subordinated notes 130 (in year 30), LLC 140 can invest the proceeds from the redemption of subordinated notes 130 into: (a) long-dated subordinated loans on similar terms to Parent 110 or to other Affiliates 120; Affiliate loans may be guaranteed by Parent.

These ECAPS preferably have “enhanced equity credit” features: (1) long-dated maturity—60 years; (2) cumulative distributions with a “mandatory deferral” of distributions upon breach of trigger; and (3) capital replacement “intent” language. “Tax deductible features” comprise: (1) ultimately on-loan to Parent of dated subordinated note; (2) the holders of the ECAPS right to liquidate the LLC and claim the subordinated note after deferral of distributions for 7 years, and ultimately accelerate the notes after a maximum of 12 years aggregate deferral; (3) creating a wholly-owned LLC subsidiary that allows reinvestment in dated subordinated notes; (4) parent issues 30-year subordinated notes to LLC in exchange for preferred proceeds; and (5) required investment of LLC assets in subordinated or third-party assets at maturity.

ECAPS are expected to achieve the same rating agency benefit as directly issued high equity content preferred stock, while achieving better cost efficiency due to tax-deductible distributions.

ECAPS Compared to Trust Preferred

Issuer: The issuer for trust preferred is typically a Delaware business trust owned by a parent. The issuer for ECAPS is preferably a Delaware business owned by a parent that invests in LLC preferred.

Taxation: The trust for trust preferred is treated as a grantor trust, and thus ignored for tax purposes. The same applies to the ECAPS trust; the LLC is treated as a partnership for tax purposes.

Accounting: A trust-preferred trust is deconsolidated under FIN 46, and the junior subordinated debt appears as equity on the balance sheet. For ECAPS, both the LLC and the trust will be deconsolidated under FIN 46, and the junior subordinated debt will appear as equity on the balance sheet.

Maturity: Maturity for trust preferred is 30-49 years; for ECAPS, 60 years.

Assets of issuer: For trust preferred, assets are the junior subordinated debt of parent 110. There is no reinvestment. For ECAPS, assets are the junior subordinated debt of the parent 110 and affiliates 120, and a small percentage (1-5%) of assets may be invested in eligible third party assets 150. At maturity of the debt, LLC 140 must reinvest in similar debt of parent 110 and affiliates 120.

Payments: For trust preferred, payments are cumulative, and deferrable for 5 years at issuer's option. All deferred payments must be repaid at the end of the 5 years. For ECAPS, payments are deferrable for 5 years at issuer's option, but deferred payments do not need to be repaid until the ECAPS are redeemed. Moreover, payments are mandatorily deferrable if certain financial metrics are breached: upon a breach of “mandatory deferral trigger” or optional deferral for 5 years, the parent 110 must use commercially reasonable efforts to issue preferred or common stock to fund distributions.

Subordination: Trust preferred is subordinated to senior and subordinated debt holders. ECAPS are subordinated to senior, subordinated debt, trust preferred.

ECAPS Equity Content

Feature 1: No or Long-dated Maturity. ECAPS have 60-year maturity with a capital replacement feature. This results in a Moody's equity content scoring of “moderate.”

Feature 2: No Ongoing Payments. ECAPS have optional deferral of subordinated notes interest up to 5 years, and a mandatory deferral of preferred dividends upon breach of a trigger. In the event of a mandatory deferral or optional deferral of more than 5 years (20 quarters) the Parent must use commercially reasonable efforts to issue common or preferred stock to ftund distributions due on ECAPS. This results in a Moody's equity content scoring of “strong.”

Feature 3: Loss Absorption. ECAPS are junior to all creditors and thus provide a loss-absorbing cushion. This results in a Moody's equity content scoring of “moderate/strong.”

Based on the above scoring, ECAPS will receive the same treatment as Basket D Preferred Stock.

Tax Treatment

ECAPS will be treated as partnership interests in LLC 140. Parent 110 and its operating subsidiaries will be entitled to deductions on interest payments made on the Subordinated Notes held by LLC 140. ECAPS holders will be allocated interest income equal to the distribution rate on LLC Preferred Securities 160.

Accounting

LLC 140 will be deconsolidated under FIN 46. On a consolidated basis, parent 110 issues 30-year subordinated debt.

Corporate

LLC 140 and trust 170 will be need to added to parent 110's shelf in order to do a registered transaction. Alternatively, ECAPS can be sold as 144A.

Example term sheets (“indicative terms and conditions) for ECAPS are provided below in the Appendices.

In an alternate embodiment, and referring again to FIG. 1, Trust 170 issues perpetual preferred securities with capital replacement language—ECAPS 180—to investors and purchases mirror LLC preferred securities 160.

LLC will on-loan to Parent 110 and at least 2 Affiliates 120 (e.g., 80% to Parent 110, 20% to Affiliates 120) the proceeds from the ECAPS offering in the form of subordinated notes 130 with a 30-year maturity. Affiliate loans may be guaranteed by Parent 110. Interest payments on the subordinated notes 130 will fund distribution payments for ECAPS 180.

At initial maturity of subordinated notes 130 (in year 30), LLC 140 can invest the proceeds from the redemption of subordinated notes 130 into: (a) long-dated subordinated loans on similar terms to Parent 110 or to other Affiliates 120; or (b) short-term, high quality third party assets 150.

These ECAPS preferably have “enhanced preferred stock” features: (1) long-dated; (2) cumulative dividends with mandatory deferral of distributions upon breach of trigger; and (3) capital replacement “intent” language. “Tax deductible features” comprise: (1) wholly-owned LLC subsidiary issues preferred securities; (2) parent issues 30-year subordinated notes to LLC in exchange for preferred proceeds; (3) 5% of LLC assets must be invested in third-party assets; and (4) required investment of LLC assets in subordinated or third-party assets at maturity.

In another embodiment, the company forms a Trust and on-loans proceeds to the Parent in the form of a 60-year subordinated loan. The Subordinated Note will have same level of subordination as the note in the LLC structure.

In addition, the Subordinated note will have deferral for 10 to 12 years. After 5 years of optional deferral, the Parent is required to sell common or preferred stock to fund distribution payments. Upon mandatory deferral, the Parent is immediately required to issue common or preferred stock to fund distribution payments. After 10 to 12 years of deferral, the holders of the Note have the right to accelerate the loan and the note becomes immediately due and payable.

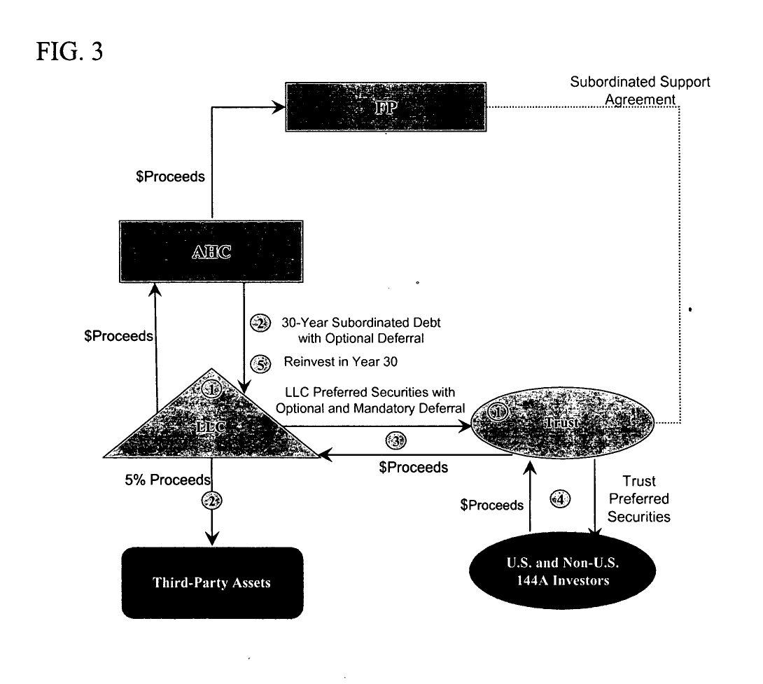

In another embodiment, the Parent may be a non-U.S. company. In that case, a more complicated arrangement may be used to obtain the tax benefits of ECAPS. For example, as depicted in FIG. 3, the Foreign Parent FP may own an American Holding Company AHC. Also formed are an LLC and a Trust.

(1) AHC Organizes LLC and Trust

Preferably, the AHC organizes LLC and in exchange for a Managing Member Interest. The AHC also organizes Trust.

(2) AHC Issues Subordinated Notes to LLC

The LLC invests in 30-year subordinated debt of AHC with a 5-year optional deferral provision. The LLC also invests 1-5% of the proceeds in high quality, short-term third party assets (e.g., A-1/P-1 CP paper).

(3) LLC Issues Preferred Securities to Trust

The Trust invests in 60-year preferred securities of the LLC with an optional deferral provision and mandatory deferral trigger event (“MDTE”). If the MDTE is breached by FP, distributions on the LLC preferred securities may only be paid from amounts received as a capital contribution from FP, the proceeds of which are raised from a sale of FP common stock. During a MDTE, payments will either be made or accrue on the AHC subordinated debt. Payments will accrue and not be made if AHC elects to utilize the optional deferral provision on the underlying subordinated debt. If payments are missed on the LLC preferred securities for a period exceeding 7 years, the LLC may be dissolved and the Trust will directly own each underlying AHC subordinated debt. If the 5-year deferral option on the subordinated debt has not been previously utilized, the 5 years of deferral is still available after liquidation of the LLC.

(4) Trust Issues Trust Preferred Securities to U.S. and Non-U.S. 144A Investors

The Trust will benefit from a subordinated Support Agreement from FP. Terms of the trust preferred securities may comprise: (a) redeemable in Year 5 (Series I) or Year 10 (Series II); and (b) redemption is subject to capital replacement intent language.

(5) Reinvestment of Subordinated Notes at Maturity

At maturity of the initial AHC subordinated debt investment in Year 30, the LLC may reinvest the proceeds at an arms-length rate in two new 30-year subordinated debts of any qualifying affiliate except for AHC. Following a reinvestment of subordinated debt of an affiliate, the affiliate debt will be rated at a minimum equal to the ratings of the ECAPS immediately prior. If reinvestment occurs in Year 30, any incremental return from a rate increase (above the stated rate) will be paid 50% to the investors of LLC preferred securities and 50% to AHC as the Managing Member.

More details regarding a preferred structure and method of this embodiment may be found in Appendix B.

Thus, in contrast to the previously described embodiments, in this embodiment the borrower on the subordinated notes is not the foreign parent (FP), but instead the U.S. subsidiary (AHC). AHC preferably also is the owner of the common securities of the Trust and the LLC. This structure allows AHC to obtain the same tax benefits as Parent in the other embodiments. However, FP is the entity on which investors rely on the credit of the group. Consequently, FP is subject to a Support Agreement (see Appendix B) that obligates FP to ensure that the Trust and the LLC have sufficient assets to meet their obligations.

While particular elements, embodiments, and applications of the present invention have been shown and described, it should be understood that the invention is not limited thereto, since modifications may be made by those skilled in the art, particularly in light of the foregoing teaching. The appended claims are intended to cover all such modifications that come within the spirit and scope of the invention.

### APPENDIX A

### ENHANCED CAPITAL ADVANTAGED PREFERRED SECURITIES (ECAPS^{SM})

### Summary Terms & Conditions

Issuer A Trust organized by a Limited Liability Company (“LLC”).
Securities Offered Enhanced Capital Advantaged Preferred Securities (“ECAPS^{SM}”).
Maturity [●][●], 2065.
Assets of the Trust Preferred Securities issued by the LLC (“LLC Preferred Securities”).
Assets of the LLC On the Issue Date, the LLC will invest 95% of its available funds in the Junior Subordinated Notes of the Parent;
   The remaining 5% of such funds will be invested in eligible third party assets.
Liquidation Preference $1,000 per LLC Preferred Security, plus accrued and unpaid distributions.
Optional Redemption Callable at the option of the Parent at the Liquidation Preference beginning [5] years from the Issue Date, and on each Distribution Date thereafter.
Distributions The LLC Preferred Securities will pay a fixed, floating or resettable rate (the “Initial Rate”) on every quarterly or semi-annual Distribution Date until [•];
   Thereafter, the rate may reset according to different terms;
   If the LLC Preferred Securities are current on all distributions (i.e., no deferred amounts), the LLC Common Securities are entitled to the remaining distributions as long as it does not reduce the Liquidation Preference of the LLC Preferred Securities;
   To the extent interest is paid on the Junior Subordinated Notes but distributions on the LLC Preferred Securities are deferred, the LLC will apply the payment to purchase additional Junior Subordinated Notes of the Parent having the same terms (except the rate) as the outstanding Junior Subordinated Notes.
Distribution Date Quarterly distributions on the [•]th of [March], [June], [September] and [December], beginning on [●][●], 2005.
Deferral of Distributions on the LLC Preferred Securities can be optionally deferred for 20 Distributions quarterly distribution periods (“Optional Deferral Event). After 20 periods, the Parent will be obligated to use all reasonable efforts to issue Common Stock or Perpetual Preferred Stock and contribute proceeds to the LLC to fund distributions on the LLC Preferred Securities;
   If a Mandatory Deferral Event occurs (see below), the Parent will have an immediate obligation to use all reasonable efforts to issue Common Stock or Perpetual Preferred Stock and contribute proceeds to the LLC to fund distributions on the LLC Preferred Securities;
   After deferral of more than 28 periods caused by either an Optional Deferral Event or Mandatory Deferral Event, the holders of the LLC Preferred Securities will be entitled to enforce their rights under the LLC Agreement, including causing a liquidation of the LLC;
   If the Mandatory Deferral Event occurs and the Parent cannot issue Common Stock or Perpetual Preferred Stock for more than 2 years, any interest accruing on the Junior Subordinated Notes after that date, in a bankruptcy or liquidation, will rank junior to any Preferred Stock claims but senior to Common Stock.
Mandatory Deferral Event [company specific]
Dividend Stopper If current and deferred distributions are not fully paid on the ECAPS^{SM}, The Parent cannot make any dividend payments on its Preferred Stock or Common Stock.
Liquidation ECAPS^{SM} will have a preference over the Common Securities of the Trust with respect to payments and in liquidation.
Income Allocation of LLC Preferred Income of the LLC (including deferred interest) will be allocated to the LLC Preferred Securities prior to allocation of LLC Common Securities;
   Income will be allocated to the LLC Preferred Securities in an amount equal to distributions on the LLC Preferred Securities at the Applicable Rate;
   Income received by the LLC above the Applicable Rate will be allocated to the LLC Common Securities until the LLC Common Securities have been allocated total income equal to twice the Applicable Rate since the date of issuance on a quarterly compounded basis;
   Thereafter, any remaining income in excess of such amount will be allocated [50/50] to the LLC Common Securities and the LLC Preferred Securities.
Loss Allocation of LLC Preferred Losses are allocated first to the LLC Common Securities until the value of the LLC Common Securities is reduced to zero;
   Losses are then allocated to the LLC Preferred Securities until the value of the LLC Preferred Securities are reduced to zero;
   Any additional losses are allocated thereafter to the LLC Common Securities.
Reinvestment of Assets At the initial maturity of the Junior Subordinated Notes (Year 30), the proceeds will be reinvested in new Junior Subordinated Notes of the Parent with similar terms;
   After the subsequent maturity of the Junior Subordinated Notes (Year 60), the LLC will be liquidated;
   To the extent interest payments are made on the Junior Subordinated Notes when distributions are deferred on LLC Preferred Securities, the proceeds will be on-loaned back to the Parent or it affiliates.
Guarantee The Parent will issue guarantees of ECAPS^{SM} and LLC Preferred Securities that qualify as unconditional guarantees for purposes of Rule 3a-5 under the 1940 Act (“non-guarantee guarantees”);
   The guarantees will cover income distributions to the extent the LLC or the Trust, as applicable, has available funds to distribute, and amounts payable upon liquidation or the assets of the LLC or Trust available for distribution upon liquidation.

### INITIAL JUNIOR SUBORDINATED NOTES

### Summary Terms & Conditions

Issuer The Parent
Securities Offered 30-year Junior Subordinated Notes.
Principal Amount $1000 per Note.
Maturity [●][●], 2035.
Interest Payment Date Quarterly payments on the [●]th of [February], [May], [August] and [November], beginning on [●][●], 2005.
Optional Deferral Event Interest payments on the Junior Subordinated Notes may be optionally deferred for up to 20 quarterly periods.
Optional Redemption Callable at the option of the Parent at the principal amount plus accrued and unpaid interest beginning [5] years from the Issue Date.
Dividend Stopper If interest payments are not made on the Junior Subordinated Notes, the Parent cannot make any dividend payments on its Preferred Stock or Common Stock.

Amendment The Junior Subordinated Notes may be amended with majority consent of ECAPS^{SM} holders, except that, if the amendment is related to the timeliness or amount of distributions, 100% consent of holders is required.

APPENDIX B
Exemplary Terms and Conditions of Trust Preferred
Securities and LLC Preferred Securities

| Issuer | Trust I and II. |
|---|---|
| Assets of the | Preferred Securities issued by LLC I and II (“LLC Preferred Securities”). |
| Trust(s) | |
| Assets of the | LLC I and II will invest 99% of its available proceeds in two 30-Year |
| LLC(s) | Subordinated Debt issued by AHC; |
| | The remaining 1% of proceeds, contributed by AHC in exchange for the |
| | Managing Member Interests, will be invested in eligible third-party assets |
| | (see Eligible Debt Securities). |
| Securities | Series I ECAPS or Trust Preferred Securities (5-Year Initial Period); |
| Offered | Series II ECAPS or Trust Preferred Securities (10-Year Initial Period). |
| Form of | Rule 144A with no registration rights; |
| Offering | Sold to qualified institutional buyers (QIB) and institutional accredited |
| | investors (IAI) only. |
| ECAPS | November [30], 2065. |
| Maturity | |
| Liquidation | $1,000 per Trust Preferred Security and LLC Preferred Security, plus |
| Amount | accrued and unpaid distributions, tradable in minimum lots of $1,000,000. |
| Optional | Callable at the Liquidation Amount at the option of FP, in whole or in |
| Redemption | part, beginning 5 years from issuance date (Series I) or 10 years from |
| | issuance date (Series II), and on each Distribution Date thereafter; |
| | Callable at a make-whole redemption price, in whole but not in part, upon |
| | a Tax Event or Investment Company Act Event. |
| Capital | FP does not intend to redeem or cause the redemption of Trust Preferred |
| Replacement | Securities and LLC Preferred Securities unless FP or an affiliate issues a |
| Provision | security with equal or greater equity characteristics. |
| Distribution | Semiannual distributions on the [30th] day of [May] and [November] |
| Date | beginning on [May] [30], 2006. |
| Distributions | The Trust Preferred Securities and LLC Preferred Securities will pay [●]% |
| | (the “Applicable Rate”) on every semiannual Distribution Date until |
| | Year 5 (Series I) or Year 10 (Series II); |
| | Thereafter, the Applicable Rate will reset to the initial credit spread plus |
| | the highest of 3-month LIBOR, 10-year Constant Maturity Treasury or |
| | 30-year Constant Maturity Treasury (“ARP Curve”); |
| | If the Trust Preferred Securities and LLC Preferred Securities are current |
| | on all distributions (i.e., no deferred amounts), FP is entitled to the |
| | remaining distributions as long as it does not reduce the Liquidation |
| | Amount; |
| | To the extent payments are made on the Subordinated Debt of AHC but |
| | deferred on the LLC Preferred Securities, LLC I and II may apply the |
| | excess payments to purchase Subordinated Debt of AHC or other FP |
| | affiliates having the same terms as the outstanding Subordinated Debt |
| | (except for rate and call provisions). |
| Deferral of | Distributions on the Trust Preferred Securities and LLC Preferred |
| Distributions | Securities can be optionally deferred for 10 semiannual periods (an |
| | “Optional Deferral Event); |

After 10 periods, FP will use its commercially reasonable efforts
to issue Common Stock and contribute proceeds to the LLC to
fund distributions on the Trust Preferred Securities and LLC
Preferred Securities

| | If a Mandatory Deferral Trigger Event occurs, FP will use its |
|---|---|
| | commercially reasonable efforts to issue Common Stock immediately and |
| | contribute proceeds to the LLC to fund distributions on the Trust |
| | Preferred Securities and LLC Preferred Securities; |
| | After deferral of more than 14 semiannual periods caused by either an |
| | Optional Deferral Event or Mandatory Deferral Trigger Event, the holders |
| | of the LLC Preferred Securities will be entitled to enforce their rights |
| | under the LLC Agreement, including causing a liquidation of LLC I and |
| | II; |
| | If a Mandatory Deferral Trigger Event occurs and FP cannot issue |
| | Common Stock for more than 2 years which is not cured (e.g., Mandatory |
| | Deferral Trigger Event continues and FP cannot issue Common Stock), |
| | holders of the LLC Preferred Securities and Trust Preferred Securities will |
| | not be entitled to income allocation associated with any further accrual of |
| | interest on the Subordinated Debt upon a liquidation of LLC I and II. |
| Mandatory | LLC I and II and AHC, as the Managing Member, will be prohibited from |
| Deferral | paying distributions on Trust Preferred Securities and LLC Preferred |
| Trigger | Securities if: |

| Event | FP trailing 4 Quarters Consolidated Net Income for the most |
|---|---|
| | recently completed Quarter is not a positive amount; and |
| | FP Adjusted Shareholders' Equity for the most recently completed |
| | 8 Quarters has declined by greater than 10%; |
| | If both conditions are met, FP will have the ability to “cure” |
| | Adjusted Shareholders' Equity for 2 forward Quarters by issuing |
| | Common Stock to increase the Adjusted Shareholders' Equity |
| | amount above the 10% decline; |

Adjusted Shareholders' Equity is the Shareholders' Equity
as reflected on FP's consolidated Balance Sheet as of any
quarter end, minus Preferred Securities, Net Unrealized
Gains and Losses on Investments, and Cumulative
Translation Adjustments;
If there is a change in IAS/IFRS that results in a
cumulative effect of a change in accounting principle or a
restatement such that the Net Income or Shareholders'
Equity amounts are different than as would have been
calculated absent such change, then the amounts will be
calculated as if such change had not occurred.

| Restrictions | During an Optional Deferral Event, if FP makes any distributions on its |
|---|---|
| on Dividends | Common or Preferred Securities, all current and deferred distributions on |
| | the Trust Preferred Securities and LLC Preferred Securities must be made; |
| | During a Mandatory Deferral Trigger Event, if current and deferred |
| | distributions are not fully paid on the Trust Preferred Securities and LLC |
| | Preferred Securities, FP management will not recommend to the Board to |
| | make any distributions on its Common or Preferred Securities. |
| Income | Income of LLC I and II (including deferred distributions) will be allocated |
| Allocation of | to the LLC Preferred Securities prior to AHC; |
| LLC | Income will be allocated to the LLC Preferred Securities in an amount |
| Preferred | equal to distributions on the LLC Preferred Securities at the Applicable |
| Securities | Rate; |
| | Income received by LLC I and II above the Applicable Rate will be |
| | allocated to AHC at a stated rate; |
| | Thereafter, any remaining income in excess of such amount will be |
| | allocated on a 50%/50% basis to AHC and the LLC Preferred Securities. |
| Loss | Losses are allocated first to AHC until the value of the Managing Member |
| Allocation of | Interests is reduced to zero; |
| LLC | Losses are then allocated to the LLC Preferred Securities until the |
| Preferred | Liquidation Amount of the LLC Preferred Securities is reduced to zero; |
| Securities | Any additional losses are allocated thereafter to AHC. |
| Eligible Debt | LLC will invest 1% of the initial proceeds in Eligible Debt Securities that |
| Securities | meet any of the following conditions: |

Any securities issued or guaranteed by the U.S. government;
Commercial paper rated by Moody's and S&P in the highest
investment grade category and maturing no later than 9 months;
Demand deposits, time deposits and certificates of deposits fully
insured by the FDIC;
Repurchase obligations with respect to any securities issued or
guaranteed by the U.S. government;
Any other security that is identified as a permitted investment of a
finance subsidiary under the Investment Company Act.

| Support | FP and FH will each provide a subordinated Support Agreement to Trust I |
|---|---|
| Agreement | and II to ensure that Trust I and II will be in a position to meet its |
| | obligations. |

Exemplary Terms and Conditions of Initial Subordinated Debt

| | |
|---|---|
| Issuer | AHC |
| Securities | 30-year Subordinated Debt: |

| Offered | Series I (5-Year Initial Period); |
|---|---|
| | Series II (10-Year Initial Period). |

| Principal | $1,000 per Security. |
|---|---|
| Amount | |
| Maturity | [May][30], 2035. |
| Distribution | Semiannual payments on the [30th] day of [May] and [November] |
| Date | beginning on [May][30], 2006; |
| | To the extent payments are made on the Subordinated Debt when |
| | distributions are deferred on the Trust Preferred Securities and LLC |
| | Preferred Securities, the proceeds will be on-loaned back to AHC or its |
| | affiliates. |
| Optional | Callable at the option of FP at the Principal Amount plus accrued and |
| Redemption | unpaid interest payments beginning 5 years from issuance date (Series I) |
| | or 10 years from issuance date (Series II). |
| Optional | Payments on the Subordinated Debt may be optionally deferred for up to |
| Deferral | 10 semiannual periods. |
| Event | |
| Amendment | The terms of the Subordinated Debt may be amended with the majority |
| | consent of the holders, except that, if the amendment is related to the |
| | timeliness or amount of payments, 100% consent of the holders is |
| | required. |
| Reinvestment | At the initial maturity of the Subordinated Debt in Year 30, LLC I and II |
| of | will reinvest the proceeds in two new Subordinated Debt of any affiliate |
| Subordinated | other than AHC (“Affiliate”) with similar terms; |
| Debt | LLC I and II may only reinvest the proceeds in Year 30 if the following |
| | conditions are satisfied (“Reinvestment Criteria”): |

The new Subordinated Debt must mature no later than 30 years
from its date of issuance and no later than 60 years from the date
of issuance of LLC Preferred Securities;
For 3 years prior to such reinvestment, there has been no default
under any mortgage, indenture or instrument related to any
indebtedness issued or guaranteed by Affiliate, nor bankruptcy of
such Affiliate, nor arrearages of distributions on any Preferred
Securities issued by Affiliate;
The terms of the new Subordinated Debt must be verified by an
Independent Financial Advisor and determined to be at least as
favorable as the terms that would have resulted from a public or
144A offering of a comparable security issued by Affiliate;
Affiliate shall not be deemed to be an investment company under
the Investment Company Act;
Following the reinvestment, the Affiliate Subordinated Debt must
be rated at a minimum equal to the ratings of the ECAPS
immediately prior;
Payment dates of the new Subordinated Debt are the same as the
Distribution Dates of the Trust Preferred Securities;
If LLC I and II are unable to reinvest proceeds in a new
Subordinated Debt meeting the above criteria, LLC I and II may
only invest the proceeds in Eligible Debt Securities.

After the subsequent maturity of the Subordinated Debt in Year 60, LLC I
and II will be liquidated.

We claim:

1. A computer based method comprising:
forming a limited liability company (“LLC”) operable to issue LLC preferred securities over a computer network;
forming a trust operable to issue trust preferred securities over said computer network and to purchase LLC preferred securities from said LLC over said computer network; and
electronically issuing over said computer network subordinated notes with at least a 30-year maturity to said LLC.

2. A computer based method comprising:
forming a trust operable to issue trust preferred securities over a computer network and to purchase LLC preferred securities over said computer network; and
electronically receiving over said computer network subordinated notes with a maturity of at least 30 years from a parent.

3. A method comprising:
forming a limited liability company (“LLC”) operable to issue LLC preferred securities;
forming a trust operable to issue trust preferred securities and to purchase LLC preferred securities from said LLC; and
issuing subordinated notes to said LLC.

4. A method as in claim 3, wherein said LLC is operable to invest proceeds from redemption of said subordinated notes into long-dated subordinated loans.

5. A method as in claim 3, wherein said subordinated notes have a maturity of at least 30 years.

6. A method as in claim 3, wherein said trust preferred securities are 60-year dated preferred securities.

7. A method as in claim 3, wherein said LLC preferred securities are 60-year dated preferred securities.

8. A method as in claim 3, wherein said LLC is operable to invest proceeds from redemption of said subordinated notes into short term, high quality third party assets.

9. A method as in claim 3, wherein said subordinated notes are 20% loaned to affiliates.

10. A method as in claim 3, further comprising guaranteeing said subordinated notes.

11. A method as in claim 3, further comprising contributing up to 5% of total capital for a managing member interest in said LLC.

12. A method as in claim 3, wherein said LLC and said trust are covered by a support agreement that ensures that each will have enough assets to pay its obligations.

13. A method comprising:
forming a trust operable to issue trust preferred securities and to purchase LLC preferred securities; and
receiving subordinated notes with a maturity of at least 30 years from a parent in exchange for a loan to said parent.

14. A method as in claim 13, wherein said subordinated notes have a deferral period of 10-12 years.

15. A method as in claim 14 wherein, after a predetermined period of optional deferral, said parent is obligated to sell common or preferred stock in order to fund distribution payments.

16. A method as in claim 15, wherein said predetermined period is five years.

17. A method as in claim 14 wherein, upon mandatory deferral, said parent is obligated to issue common or preferred stock in order to fund distribution payments.

18. A method as in claim 14 wherein, after 10-12 years of deferral, holders of said subordinated notes have a right to accelerate said loan and said notes become immediately due and payable.

19. A security that: (a) is tax deductible, and (b) receives equity credit above 50% from Moody's and S&P.

20. A security as in claim 19, wherein said equity credit is similar to that of perpetual preferred stock.

21. A security as in claim 19, wherein said security is a preferred security issued by a trust,
wherein said trust is operable to purchase LLC preferred securities from an LLC, and
wherein said LLC is operable to purchase subordinated notes from a parent with funds received from said trust in exchange for said LLC preferred securities.

22. A security as in claim 21, wherein said LLC is operable to invest proceeds from redemption of said subordinated notes into long-dated subordinated loans.

23. A security as in claim 21, wherein said LLC preferred securities are 60-year dated preferred securities.

24. A security as in claim 21, wherein said security is a 60-year dated preferred security.

25. A security as in claim 21, wherein said LLC is operable to invest proceeds from redemption of said subordinated notes into short term, high quality third party assets.

26. A security as in claim 21, wherein said subordinated notes are 20% loaned to affiliates.

27. A security as in claim 21, wherein said subordinated notes are guaranteed by said parent.

28. A security as in claim 21, wherein said LLC and said trust are covered by a support agreement that ensures that each will have enough assets to pay its obligations.
